(19) United States
(12) Patent Application Publication
(10) Pub. No.: US 2021/0170751 A1
(43) Pub. Date: Jun. 10, 2021

(54) IMAGE FORMING APPARATUS

(71) Applicant: KYOCERA Document Solutions Inc., Osaka-shi (JP)

(72) Inventor: Masaki BABA, Osaka-shi (JP)

(21) Appl. No.: 17/106,544

(22) Filed: Nov. 30, 2020

(30) Foreign Application Priority Data
Dec. 6, 2019 (JP) 2019-221149

(51) Int. Cl. B41J 2/165; G06F 3/12; B41J 2/045; B41J 2/205; B41J 2/21

(52) U.S. Cl. CPC B41J 2/16517; G06F 3/1296; B41J 2/04586; B41J 2/205; B41J 2/2132; B41J 2/04536

(57) ABSTRACT

An image forming apparatus includes a head, a first controller, and a second controller. When calculating an amount of ink used, the first controller obtains an estimated number of discharges, which is the number of dots of the ink to be discharged, on a basis of print image data which is image data used for printing, without using information on an actual number of discharges of the ink at the head. The first controller obtains a print usage on a basis of a value obtained by multiplying the obtained estimated number of discharges by a discharged droplet amount per ink discharge. The print usage is the amount of the ink used, discharged onto a paper for printing each page of a print job.

### INCORPORATION BY REFERENCE

This application is based upon, and claims the benefit of priority from, corresponding Japanese Patent Application No. 2019-221149 filed in the Japan Patent Office on Dec. 6, 2019, the entire contents of which are incorporated herein by reference.

### BACKGROUND

### Field of the Invention

The present disclosure relates to an image forming apparatus that discharges ink and performs printing.

### Description of Related Art

An ink jet type image forming apparatus discharges ink and performs printing. The ink jet type image forming apparatus may measure ink consumption.

An image forming apparatus may include a plurality of control boards (controller). In a large image forming apparatus or a multifunctional image forming apparatus, it may be difficult to control all members with only one control board. In such an image forming apparatus, a plurality of control boards are often provided. A CPU and a memory are provided in each control board. Each control board has a different role and a different process. For example, a control board in charge of ink discharge control and a control board (control board in charge of management) for calculating ink consumption are provided separately.

Conventionally, the actual number of ink discharges of a head is counted, and the number of counted discharges is multiplied by the amount of ink per discharge to obtain ink consumption. When the control board in charge of ink discharge control and the control board for calculating the ink consumption are different, in order to obtain the ink consumption on the basis of the count value of the actual number of discharges, a large amount of data must be frequently exchanged between the control boards for each page. However, there is data to be exchanged other than the data for calculating the ink consumption. Frequent exchange of many data has the problem that it may interfere with high-speed processing. For example, communication between control boards may be delayed and a print process may take a long time.

### SUMMARY

An image forming apparatus according to the present disclosure includes a head, a first controller, and a second controller. The head includes a plurality of nozzles. The head discharges ink from the nozzle. The first controller manages a print job using the head. The first controller calculates the amount of the ink used in the print job. The second controller controls ink discharge at the head on a basis of an instruction of the first controller. When calculating the amount of the ink used, the first controller obtains an estimated number of discharges, which is the number of dots of the ink to be discharged, on a basis of print image data which is image data used for printing, without using information on an actual number of discharges of the ink at the head. The first controller obtains a print usage on a basis of a value obtained by multiplying the obtained estimated number of discharges by a discharged droplet amount per ink discharge. The print usage is the amount of the ink discharged onto a paper for printing each page of the print job

### BRIEF DESCRIPTION OF THE DRAWINGS

FIG. 1 is a diagram illustrating an example of an image forming apparatus according to an embodiment;

FIG. 2 is a diagram illustrating an example of the image forming apparatus according to the embodiment;

FIG. 3 is a diagram illustrating an example of the image forming apparatus according to the embodiment;

FIG. 4 is a flowchart illustrating an example of calculation of an amount of ink used in the image forming apparatus according to the embodiment;

FIG. 5 is a flowchart illustrating an example of calculation of a print usage according to the embodiment;

FIG. 6 is a diagram illustrating an example of a mechanism for performing maintenance of the image forming apparatus according to the embodiment; and

FIG. 7 is a flowchart illustrating an example of calculation of a purge usage according to the embodiment.

### DETAILED DESCRIPTION

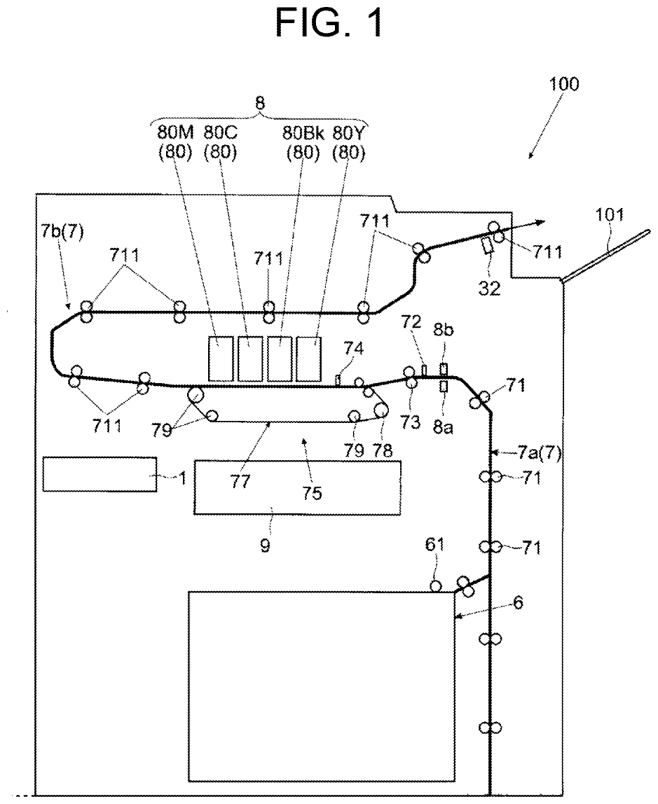

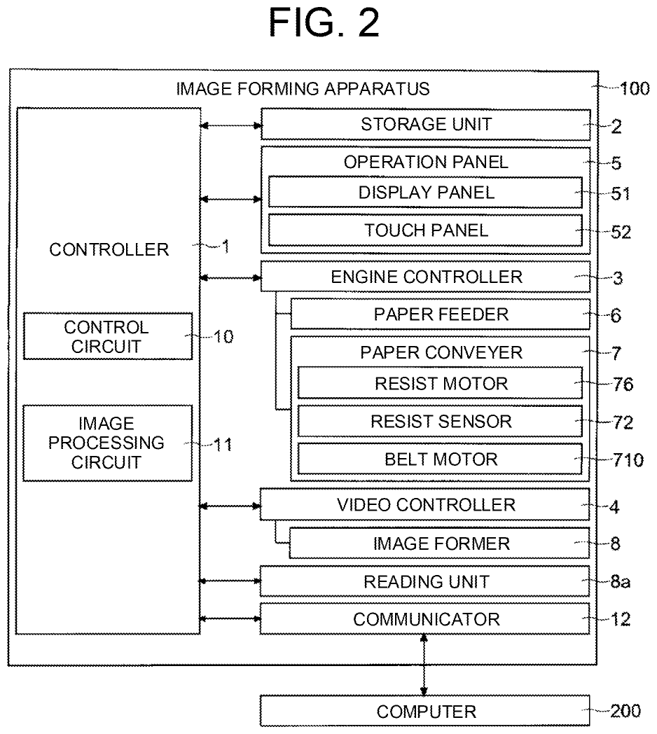

Hereinafter, an image forming apparatus 100 according to an embodiment of the present disclosure will be described with the use of FIGS. 1 to 7. The image forming apparatus 100 described later is a printer. The image forming apparatus 100 may be, for example, a multifunction peripheral. The image forming apparatus 100 performs printing using ink.

(Overview of Image Forming Apparatus 100)

First, the overview of an image forming apparatus 100 according to an embodiment will be described with the use of FIGS. 1 to 3. FIGS. 1 to 3 are diagrams illustrating an example of the image forming apparatus 100 according to the embodiment.

The image forming apparatus 100 performs printing on a paper. The image forming apparatus 100 performs printing using ink. The image forming apparatus 100 includes a controller 1 (corresponding to the first controller), a storage unit 2, an engine controller 3, a video controller 4 (corresponding to the second controller), an operation panel 5, a paper feeder 6, a paper conveyer 7, an image former 8, and a communicator 12. The controller 1, the engine controller 3, and the video controller 4 are, for example, boards.

The controller 1 issues an operation instruction for each component of the image forming apparatus 100. That is, the controller 1 manages a print job using a line head 80. For example, at the time of a print job, the controller 1 issues an instruction for paper feeding and paper conveyance to the engine controller 3. The engine controller 3 controls the operations of the paper feeder 6 and the paper conveyer 7 on the basis of this instruction. At the time of the print job, the controller 1 generates print image data i1. and generates ink discharge image data i2 on the basis of the print image data i1. The controller 1 transmits the print instruction and the ink discharge image data i2 to the video controller 4. The video controller 4 discharges ink from the line head 80 on the basis of the ink discharge image data i2.

The controller 1 is a board including a control circuit 10 and an image processing circuit 11. For example, the control circuit 10 is a CPU. The control circuit 10 performs calculations and processing on the basis of the control program and control data stored in the storage unit 2. The storage unit 2 includes a non-volatile storage device such as a ROM and a storage (an HDD, a flash ROM). In addition, the storage unit 2 includes a volatile storage device such as a RAM. The image processing circuit 11 performs image processing of the image data used for printing (print image data i1). Moreover, the controller 1 obtains the amount of ink consumed by one print job for each calculation item (the details will be described later).

The engine controller 3 includes an engine control circuit 30 and an engine memory 31. The engine control circuit 30 is, for example, a CPU. The engine memory 31 stores programs and data related to paper feed control and paper conveyance control.

The video controller 4 is a board or a chip. The video controller 4 includes a video control circuit 40 and a second image memory 41. The video control circuit 40 performs image processing and controls the ink discharge of the line head 80. The second image memory 41 is a memory for storing the data required for image processing and ink discharge. The second image memory 41 is, for example, a DRAM.

The operation panel 5 includes a display panel 51 and a touch panel 52. The controller 1 causes the display panel 51 to display a setting screen and information. The display panel 51 displays an operation image such as a key, a button, and a tab. The touch panel 52 detects a touch operation on the display panel 51. The controller 1 recognizes an operated operation image on the basis of the output of the touch panel 52. The controller 1 recognizes a setting operation performed by a user.

The paper feeder 6 accommodates a bundle of paper. The paper feeder 6 includes a paper feed roller 61. The paper feed roller 61 contacts the highest-level paper among the papers set in the paper feeder 6. A paper feed motor (not illustrated) for rotating the paper feed roller 61 is provided. At the time of a print job, the engine controller 3 rotates the paper feed motor to rotate the paper feed roller 61. As a result, a paper is fed from the paper feeder 6 to the paper conveyer? (first conveyer 7a). A separate paper feed device (not illustrated) can be installed to the side surface of the image forming apparatus 100 (on the right side in FIG. 1). The connected paper feed device can accommodate a large amount of paper and feeds the paper to the first conveyer 7a.

The paper conveyer 7 conveys a paper. The paper conveyer 7 includes the first conveyer 7a and a second conveyer 7b. The first conveyer 7a conveys the paper supplied from the paper feeder 6 toward the image former 8. The second conveyer 7b conveys the paper that has passed through the image former 8 (line head 80) toward an ejection tray 101. A separate post-processing device (not illustrated) can be installed to the side surface of the image forming apparatus 100 (left side in FIG. 1). When the post-processing device is installed, the image forming apparatus 100 can feed a printed paper to the post-processing device. In this case, the controller 1 causes the post-processing device to perform post-processing.

The engine controller 3 conveys the paper supplied from the paper feeder 6 to the first conveyer 7a toward the image former 8. As illustrated in FIG. 1, the first conveyer 7a includes a first conveyance roller pair 71, a reading unit 8a and a light source 8b, a resist sensor 72, a resist roller pair 73, a paper sensor 74, and a conveyance unit 75 in this order from the upstream side in the paper conveyance direction.

A plurality of first conveyance roller pairs 71 are provided. In order to rotate each first conveyance roller pair 71, a first conveyance motor (not illustrated) is provided. At the time of a print job, the engine controller 3 rotates the first conveyance motor. In addition, a resist motor 76 is provided to rotate the resist roller pair 73. The engine controller 3 controls the rotation of the resist motor 76 to control the rotation of the resist roller pair 73.

The resist sensor 72 is provided in the more upstream side than the resist roller pair 73 in the paper conveyance direction. The output level of the resist sensor 72 changes depending on whether the presence of a paper is detected. The output of the resist sensor 72 input to the engine controller 3. The engine controller 3 recognizes that, the front edge of the paper has reached the resist sensor 72, on the basis of the output. The engine controller 3 recognizes that the rear edge of the paper has passed through the resist sensor 72.

When the paper reaches the resist roller pair 73, the engine controller 3 has stopped the resist roller pair 73. For example, when the rear edge of the paper passes through the resist sensor 72, the engine controller 3 stops the resist roller pair 73. On the other hand, the engine controller 3 rotates the first conveyance roller pair 71 which is in one more upstream side than the resist roller pair 73. The front edge of the paper hits the resist roller pair 73. The hit paper bends, and the front edge of the paper follows the nip of the resist roller pair 73. The skew of the paper is corrected. When a specified bend creation time elapses after recognizing the arrival of the front edge of the paper on the basis of the output of the resist sensor 72, the engine controller 3 rotates the resist roller pair 73. This causes the paper to be fed toward the conveyance unit 75.

The conveyance unit 75 includes a conveyance belt 77, a drive roller 78, and a driven roller 79. The conveyance belt 77 is hung around the drive roller 78 and the driven roller 79. A belt motor 710 is provided to rotate the drive roller 78. During a print job, the engine controller 3 rotates the belt motor 710 and causes the conveyance belt 77 to go around. The conveyance belt 77 sucks a paper. For example, a plurality of holes are opened in the conveyance belt 77. A suction device that sucks air from the holes is provided (not illustrated). The position of the paper on the belt can be fixed by suction.

The reading unit 8a reads a conveyed paper. FIG. 1 illustrates an example in which the reading unit 8a and the light source 8b are provided between the first conveyance roller pair 71 and the resist sensor 72. The reading unit 8a includes a conveyance image sensor. The conveyance image sensor is a line sensor. The conveyance image sensor includes a plurality of light receiving elements. The plurality of light receiving elements are lined up in the main scanning direction (the direction perpendicular to the paper surface in FIG. 1, and the direction perpendicular to the paper conveyance direction). The conveyance image sensor reads the conveyed paper.

A plurality of second conveyance roller pairs 711 are provided in the second conveyer 7b. A second conveyance motor (not illustrated) is provided to rotate each second transport roller pair 711. At the time of a print job, the engine controller 3 rotates the second conveyance motor.

In this way, the engine controller 3 controls the operations of the paper feeder 6 and the paper conveyer 7. For example, the engine control circuit 30 controls the rotation of the resist motor 76 and the belt motor 710. In addition, the engine control circuit 30 recognizes the paper transfer status on the basis of the outputs of the resist sensor 72 and the paper sensor 74.

The engine control circuit 30 notifies the video controller 4 that, for example, the paper sensor 74 has detected the arrival of the front edge of a paper. When a preliminarily specified waiting time elapses from the notification, the video controller 4 (video control circuit 40) starts printing a page (drawing a first line). The waiting time is, for example, a time obtained by dividing the distance from the paper sensor 74 to the nozzle of the line head 80 by an ideal (on-specification) paper conveyance speed.

The image former 8 performs printing on a conveyed paper. The image former 8 discharges ink to the conveyed paper. As illustrated in FIG. 1, the image former 8 includes four line heads 80. A line head 80Bk discharges black ink. A line head 80Y discharges yellow ink. A line head 80C discharges cyan ink. A line head 80M discharges magenta ink. Each line head 80 is fixed. Each line head 80 is provided above the conveyance unit 75 (conveyance belt 77). A certain gap is provided between each line head 80 (nozzle on the lower surface) and the conveyance belt 77. A paper passes through this gap.

The line head 80 includes a plurality of nozzles. The nozzles are aligned in the direction perpendicular to the paper conveyance direction (main scanning direction) (the direction perpendicular to the paper surface in FIG. 1). The opening of each nozzle faces the conveyance belt 77. That is, the nozzle faces downward. The controller 1 supplies the ink discharge image data i2 to the video controller 4. The video controller 4 causes the line head 80 to perform ink discharge from the nozzle to the conveyed paper on the basis of this ink discharge image data i2. The ink lands on the conveyed paper and an image is recorded (formed).

The controller 1 is connected to the communicator 12. The communicator 12 includes a communication connector, a communication control circuit, and a communication memory. The communication memory stores communication software. The communicator 12 communicates with a computer 200. The computer 200 is, for example, a PC or a server. The controller 1 receives print job data from the computer 200. The print job data includes print settings and print content. For example, the print job data includes data written in a page description language. The controller 1 (image processing circuit 11) analyzes the received (input) print job data. The controller 1 generates raster data (print image data i1) on the basis of the analysis result of the print job data.

The image processing circuit 11 applies, to the generated print image data i1, image processing according to the print settings. The image processing circuit 11 eventually performs the halftone processing of the print image data it and generates the ink discharge image data i2. The ink discharge image data i2 is data in which the value of each pixel indicates the discharge or non-discharge of the ink of each nozzle (each pixel). For example, the image processing circuit 11 generates the ink discharge image data i2 for each color. The controller 1 stores the generated ink discharge image data i2 in the first image memory 21. The storage unit 2 includes the first image memory 21. The first image memory 21 is, for example, a DRAM.

The controller 1 transmits the ink discharge image data i2 of the first image memory 21 to the second image memory 41 for each color. The second image memory 41 stores the received ink discharge image data i2. In addition, the video control circuit 40 generates mask data i3 on the basis of the conveyed read image data obtained by reading by the reading unit 8a. The mask data i3 is data for preventing ink discharge to a part where a paper is not present. The video control circuit 40 edits the ink discharge image data i2 on the basis of the mask data i3. Specifically, the video control circuit 40 changes the pixel value of the pixel of the ink discharge image data i2, that discharges ink to the outside of a paper, so that the value indicates non-discharge. The video control circuit 40 generates and edits the ink discharge image data i2 for each color. The video controller 4 supplies the edited ink discharge image data i2 to the line head 80. The line head 80 discharges ink on the basis of the received ink discharge image data i2 (ink discharge image data i2 edited in a mask process).

The video controller 4 (video control circuit 40) can count the number of ink discharges from the nozzle for each line head 80. For example, the video controller 4 can count the number of ink discharges on a page-by-page basis (the number of dots of discharged ink). For example, the video controller 4 counts the number of discharges, such as 500,000 times and 1 million times.

(Calculation of Amount of Ink Used)

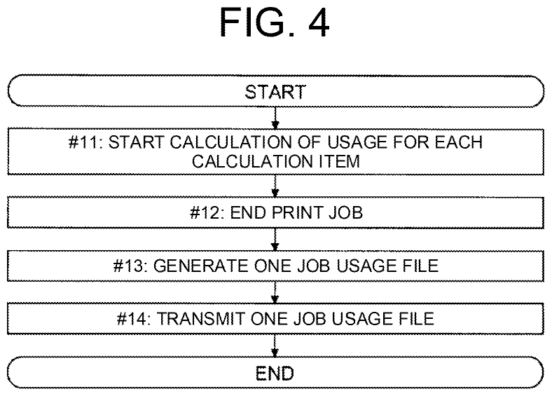

Next, the overview of the calculation of an amount of ink used in the image forming apparatus 100 according to the embodiment will be described with the use of FIG. 4. FIG. 4 is a flowchart illustrating an example of the calculation of the amount of ink used in the image forming apparatus 100 according to the embodiment.

Each time a print job is performed, the controller 1 obtains the amount of ink consumed by the print job (amount of ink used). That is, the controller 1 obtains the amount of ink used as a unit of one job. When obtaining the amount of ink used, the controller 1 does not acquire the information on the number of ink discharges from the video controller 4. The controller 1 obtains the amount of ink used only by calculation.

The controller 1 obtains the amount of ink used for each preliminarily specified calculation item. For example, the calculation item is a normal print usage, an error print usage, and a purge usage. The details of each usage will be described later. Items other than the above may be added as a calculation item. The controller 1 outputs data (one job usage file) that summarizes the values of each calculated item. The one job usage file is data that summarizes the values obtained for each color for each calculation item. The user can check the one job usage file. By checking, the user can grasp how much ink is consumed for each calculation item.

The start in FIG. 4 is the time when a print job is started. The controller 1 starts the calculation of the usage for each color and each calculation item (step #11). Eventually, the print job ends (step #12). When the print job ends, the controller 1 generates one job usage file (step #13). Then, the controller 1 causes the communicator 12 to transmit the one job usage file to the computer 200 (step #14 to END).

The destination of the one job usage file may be fixed. For example, the computer 200 for managing the image forming apparatus 100 or the shared server can be defined as the destination. In this case, the address of the computer 200 that transmits the one job usage file is preset. For example, the operation panel 5 accepts the setting of the address of the computer 200. The controller 1 non-volatilely stores the set address in the storage unit 2. When transmitting the one job usage file, the controller 1 refers to the stored address. In addition, the controller 1 may transmit the one job usage file to the computer 200 that has transmitted the print job data.

The user can check the content of the one job usage file on the computer 200. For example, when the one job usage file is opened, the computer 200 displays the content of the one job usage file on the display of the computer 200. By checking the content, the user can grasp how much ink has been used on which calculation item. It is possible to check whether there is a problem with the amount of ink used. It is possible to grasp various information on the basis of the one job usage file.

(Normal Print Usage and Error Print Usage)

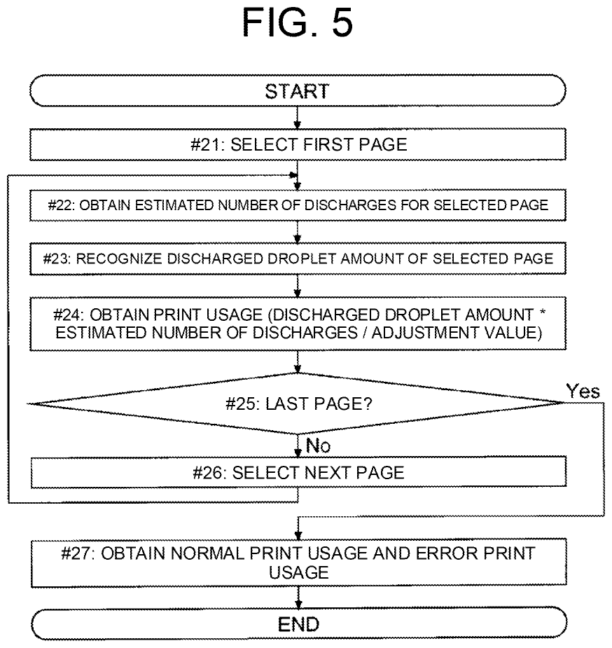

Next, an example of calculation of the normal print usage and the error print usage according to the embodiment will be described with the use of FIG. 5. FIG. 5 is a flowchart illustrating an example of calculation of the normal print usage and error print usage according to the embodiment.

The control circuit 10 or the image processing circuit 11 may calculate the normal print usage and the error print usage. The start in FIG. 5 is the time when the calculation of amount of ink used starts with the start of a print job. First, the controller 1 selects the first page of the print job (step #21). The controller 1 obtains the estimated number of discharges of the selected page for each color, on the basis of the print image data i1 of the selected page (step #22).

The estimated number of discharges is an estimated value of the number of dots discharged when printing on the basis of the print image data i1 of the selected page. The print image data i1 used to calculate the estimated number of discharges is the image data before halftone processing (dot processing). In other words, the controller 1 calculates the estimated number of discharges with the use of the image data before conversion to the ink discharge image data i2. The image data before conversion to the format supplied to the video controller 4 can be used. For example, the controller 1 calculates the estimated number of discharges with the use of the image data obtained by converting the image data generated by a rasterizing process into a CMYK format.

Specifically, the controller 1 calculates the estimated number of discharges with the use of a primary conversion table. The storage unit 2 non-volatilely stores the conversion table. In the conversion table, the number of discharges (number of dots) corresponding to the pixel values (a density value, a gradation value) of the pixels of the print image data i1 is defined. For example, the higher the pixel value, the larger the defined number of discharges. The lower the pixel value, the smaller the defined number of discharges. For example, the number of discharges corresponding to a pure white pixel value is zero. The conversion table may be prepared for each color. The controller 1 converts all the pixels of the print image data i1 of one page into the number of discharges. The controller 1 obtains the total number of discharges converted for each color. The controller 1 uses the obtained total value as the estimated number of discharges. The estimated number of discharges may be obtained by an other method.

Next, the controller 1 recognizes a discharged droplet amount on the printing of the selected page (step #23). The discharged droplet amount from the line head 80 has multiple stages. The video controller 4 can control the discharged droplet amount by making different the signal waveform and the amplitude of the waveform of the voltage applied to the piezo element attached to each nozzle. The video controller 4 can change the amount of ink used per discharge (the discharged droplet amount) depending on the type of paper used for printing.

For example, the video controller 4 increases the discharged droplet amount for an ink jet mat paper compared to an ink jet plain paper. Since the mat paper absorbs ink better than the plain paper and tends to have a low concentration. For a paper (an other paper) that is neither an ink jet mat paper nor an ink jet plain paper, the video controller 4 may set the discharged droplet amount to be less than that of the ink plain paper.

The operation panel 5 accepts the setting of the type of paper used for printing (a paper set in the paper feeder 6). The controller 1 recognizes the type of a printing paper on the basis of the output of the operation panel 5. The controller 1 recognizes the amount of ink used (the discharged droplet amount) ejected for one discharge when the video controller 4 performs printing. The controller 1 sets the discharged droplet amount to a value according to the paper used for printing.

Then, the controller 1 obtains the print usage of the selected page (step #24). Specifically, the controller 1 obtains the print usage on the basis of the following formula 1.

print usage=discharged droplet amount×estimated number of discharges÷adjustment value (Formula 1)

The adjustment value is a value for matching the resolution of the print image data i1 to the print resolution of the line head 80. In some cases, due to the specifications, the resolution of the print image data i1 generated by the image processing circuit 11 may be fixed. In addition, the print resolution of the line head 80 is determined by the pitch of the nozzle. If the resolution of the print image data i1 and the print resolution are different, the print usage cannot be calculated correctly. Accordingly, the estimated number of discharges is adjusted with the use of the adjustment value.

For example, the resolution of the print image data i1 is 1200 dpi. The print resolution of the line head 80 is 600 dpi. It is necessary to match the estimated number of discharges (dots) counted on the basis of 1200 dpi to 600 dpi. If the vertical 1200 dpi is 600 dpi and the horizontal 1200 dpi is 600 dpi, the number of dots will be 1/2×1/2=1/4. In this case, the controller 1 divides the estimated number of discharges by the adjustment value “4”.

Next, the controller 1 confirms whether the selected page is the last page of the print job (step #25). When the selected page is not the last page (No in step #25), the controller 1 selects the next page (step #26). Then, the controller 1 executes step #22 (returns to the step #22). In this way, the controller 1 calculates the print usage for each page. When the selected page is the last page of the print job, the controller 1 obtains the normal print usage and the error print usage (step #27). Then, the controller 1 ends this flowchart (END).

The normal print usage is the total of the print usage of the pages ejected to the ejection tray 101 without an error. In the print job, even if an error occurs, error processing is performed, and finally all the pages are ejected to the ejection tray 101. Therefore, the controller 1 may use the total print usage of all pages as the normal print usage. The error print usage is the total print usage of the pages that have not been ejected to the ejection tray 101 by an error. If no error occurs, the error print usage will be zero.

The engine controller 3 can recognize the occurrence of a paper conveyance error (paper jam error). In addition to the resist sensor 72 and paper sensor 74, a sensor that detects the arrival and passage of a paper is installed in the paper conveyance path (not illustrated). The engine controller 3 detects the paper transport error on the basis of the outputs of these sensors. When there is a sensor that should detect the paper arrival but cannot detect the paper arrival beyond an allowable time, the engine controller 3 determines that a paper conveyance error has occurred. When there is a sensor that should detect paper passage but cannot detect paper passage beyond an allowable time, the engine controller 3 determines that a paper conveyance error has occurred.

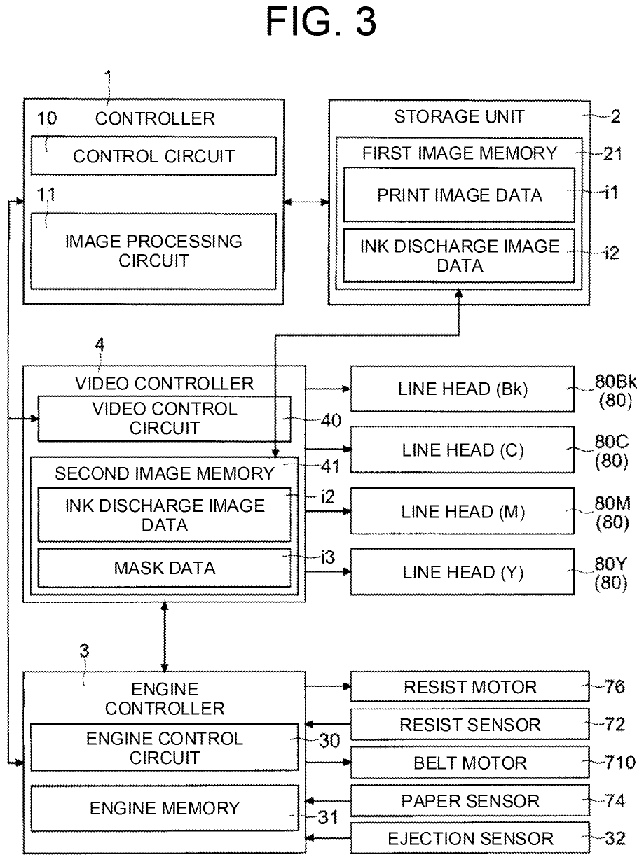

When determining that a paper conveyance error has occurred, the engine controller 3 stops the paper conveyance. In addition, the image forming apparatus 100 includes an ejection sensor 32 in the paper ejection port to the ejection tray 101 (see FIGS. 1 and 3). The engine controller 3 recognizes whether the paper has been ejected on the basis of the output of the ejection sensor 32. The engine controller 3 grasps which page has been ejected normally. The engine controller 3 grasps which page has not been ejected to the ejection tray 101 due to the paper conveyance error. When the paper conveyance is stopped by the paper conveyance error, the user performs work to eliminate the error. For example, the user removes the paper remaining in the machine. After removal, the engine controller 3 resumes paper conveyance, and the video controller 4 resumes ink discharge to the paper.

When determining that a paper conveyance error has occurred, the engine controller 3 notifies the controller 1 and the video controller 4 that the engine controller 3 has determined that the paper conveyance error has occurred. In response to this notification, the video controller 4 stops the ink discharge from the line head 80. In addition, the engine controller 3 notifies the controller 1 of the pages that have not been ejected to the ejection tray 101 among the pages on which ink has been discharged. The controller 1 uses the total print usage of the notified page as the error print usage.

(Purge Usage)

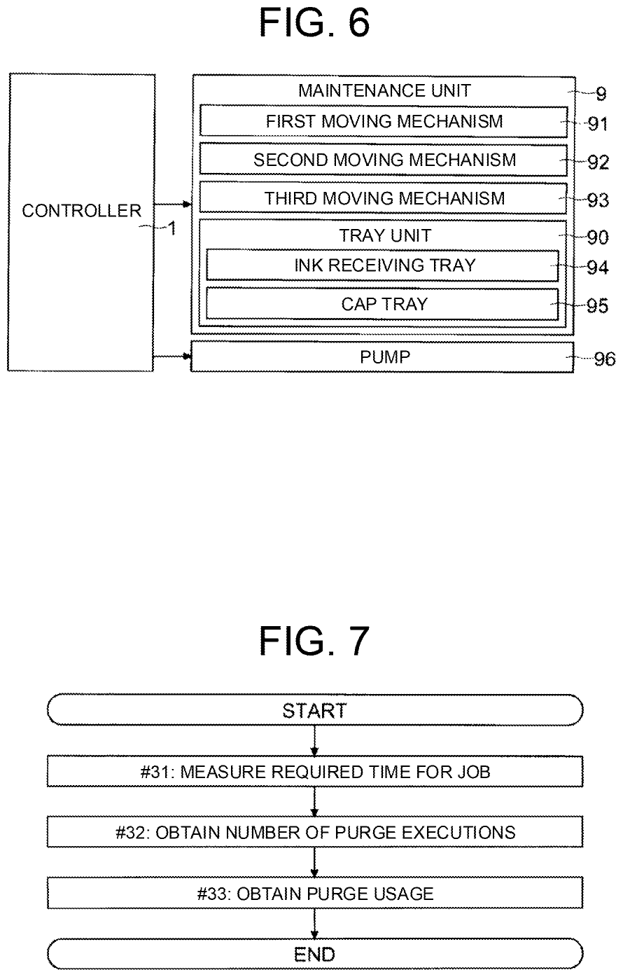

Next, an example of calculation of a purge usage according to the embodiment will be described with the use of FIGS. 1, 6 and 7. FIG. 6 is a diagram illustrating an example of a mechanism for performing maintenance of the image forming apparatus 100 according to the embodiment. FIG. 7 is a flowchart illustrating an example of calculation of a purge usage according to the embodiment.

For example, when printing a printed matter with margins consecutively, the ink is not discharged from the nozzle facing the margins. The ink components (solvent) are volatilized (evaporated) from the ink surface of a nozzle. For a nozzle that does not discharge ink for a long time, the viscosity of the ink increases due to the volatilization of the components. For a nozzle with a high viscosity, it becomes difficult for the ink to be discharged. If the viscosity continues to increase, the nozzle may eventually become clogged and the ink may not be discharged.

Therefore, the controller 1 causes the image former 8 (line head 80) to perform a purge process every certain time after the start of printing. The purge process is a process of discharging ink from the line head 80 to prevent clogging. The purge process is one of the processes for maintenance. In the purge process, printing is interrupted. During the purge process, the engine controller 3 does not feed or convey a paper.

The image forming apparatus 100 includes a maintenance unit 9 for the maintenance of the line head 80. As illustrated in FIG. 1, the maintenance unit 9 is provided below the line head 80. As illustrated in FIG. 6, the maintenance unit 9 includes a tray unit 90, a first moving mechanism 91, a second moving mechanism 92, and a third moving mechanism 93.

The tray unit 90 includes an ink receiving tray 94 and a cap tray 95. The ink receiving tray 94 is a tray for receiving and collecting the ink discharged from the line head 80 (nozzle). The cap tray 95 is provided with an anti-drying cap. The anti-drying cap can be fitted to the nozzle surface (lower surface) of the line head 80. The nozzle surface of the line head 80 can be sealed. By fitting the anti-drying cap, evaporation of an ink component can be prevented.

The first moving mechanism 91 moves the conveyance unit 75 in the horizontal direction (the direction perpendicular to the paper surface in FIG. 1). When printing, the first moving mechanism 91 moves and positions the conveyance unit 75 so as to be below the line head 80. When performing the purge process or fitting the anti-drying cap, the controller 1 moves the conveyance unit 75 to the first moving mechanism 91 toward a retracted position. The retracted position of the conveyance unit 75 is a position that is deviated from positions below the line head 80.

The second moving mechanism 92 moves the tray unit 90 in the up-down direction (vertical direction). When performing the purge process or fitting the anti-drying cap, after moving the conveyance unit 75 to the retracted position, the controller 1 raises the tray unit 90 to the second moving mechanism 92. This causes the tray unit 90 to move toward the lower surface of the line head 80. The second moving mechanism 92 moves the tray unit 90 to a position below the line head 80. When the purge process is completed, or when the anti-drying cap is not fitted, the controller 1 causes the second moving mechanism 92 to move the tray unit 90 to a lower limit position. After the lowering, the controller 1 moves the conveyance unit 75 to the first moving mechanism 91 toward the lower side of the line head 80.

The third moving mechanism 93 is a mechanism for exchanging the tray facing the lower surface (nozzle surface) of the line head 80. At the time of a purge process, the third moving mechanism 93 positions the ink receiving tray 94 below the line head 80. When fitting the anti-drying cap, the third moving mechanism 93 positions the cap tray 95 below the line head 80.

For the movement of units and trays, the first moving mechanism 91, the second moving mechanism 92, and the third moving mechanism 93 include mechanical elements such as motors, gears, belts, pulleys, belts, and wires. The controller 1 controls the rotation of the motors and controls the operation of the maintenance unit 9.

For a purge process, the image forming apparatus 100 also includes a pump 96. During the purge process, the controller 1 operates the pump 96. The pump 96 is a device that presses ink in the direction of feeding to each line head 80. As a result, the ink oozes out from all the nozzles. The ink is pushed out from the nozzles. By applying this pressure, viscosity-increased ink can be discharged to the outside of the nozzles.

The controller 1 performs a purge process at an execution interval preliminarily specified. The execution interval is, for example, about several tens of minutes to 60 minutes. The operation panel 5 may accept the setting of the execution interval. In this case, the controller 1 performs a purge process on all four color line heads 80 at the set execution interval. When the execution interval elapses from the start of a print job or a previous purge process, the controller 1 pauses printing, performs a purge process, and resumes printing after the purge process.

An example of calculation of a purge usage will be described with the use of FIG. 7. The start in FIG. 7 is the time when a print job is started. First, the controller 1 (control circuit 10) measures the required time for the job (step #31). The required time for the job is the time from the start to the end of printing. The controller 1 divides the required time for the job by a purge interval to obtain the number of purge executions (step #32). For example, the controller 1 truncates the fractional part of the number of purge executions. Next, the controller 1 calculates the purge usage by multiplying the obtained number of purge executions by the amount of ink used in one purge process (step #33). The controller 1 obtains the purge usage for each color. This makes it possible to obtain the amount of ink used in the purge process during one print job.

The amount of ink used in one purge process is preliminarily specified (for example, 1000 to several thousand μl). The amount is common to each color. The controller 1 multiplies the amount of ink used and the number of executions. When a purge process occurs for all four colors at the same time, the purge usage is the same for all colors.

In this way, the image forming apparatus 100 according to the embodiment includes a head (line head 80), a first controller (controller 1), and a second controller (video controller 4). The head includes a plurality of nozzles. The head discharges ink from the nozzle. The first controller manages a print job using the head. The first controller calculates the amount of ink used in the print job. The second controller controls the ink discharge at the head on the basis of an instruction of the first controller. When calculating the amount of ink used, the first controller obtains the estimated number of discharges, which is the number of dots of ink to be discharged, on the basis of print image data it which is image data used for printing, without using the information on the actual number of ink discharges at the head. The first controller obtains a print usage on the basis of a value obtained by multiplying the obtained estimated number of discharges by a discharged droplet amount per ink discharge. The print usage is the usage of ink discharged onto a paper for printing each page of the print job.

It is possible to accurately calculate the amount of ink used (print usage) without acquiring the data of the actual number of ink discharges from the second controller. An amount of ink used can be calculated accurately while reducing the amount of data exchanged between the first controller and the second controller so as not to interfere with high-speed processing other than the calculation of the amount of ink used.

The first controller performs the halftone processing of the print image data it to generate the ink discharge image data i2. The first controller transmits the generated ink discharge image data i2 to the second controller. The first controller obtains the estimated number of discharges on the basis of the print image data i1 before the halftone processing. The print usage can be calculated on the basis of the image data (print image data i1) before the halftone processing. The calculation of the print usage can be started without waiting for the progress of image processing. The print usage can be calculated at high speed.

The second controller changes the discharged droplet amount in accordance with the type of paper used for printing. The first controller sets the discharged droplet amount multiplied to the estimated number of discharges to be a value according to the type of paper used for printing. The discharged droplet amount to be used for calculation can be matched with the discharged droplet amount in actual printing. The print usage can be calculated accurately.

When calculating the print usage, the first controller obtains, as the print usage, a value obtained by multiplying the value obtained by dividing the estimated number of discharges by the adjustment value for adjusting the resolution of the print image data it to the print resolution of the head and the discharged droplet amount. The estimated number of discharges can be adjusted to a value according to the print resolution (nozzle pitch) of the line head 80. The print usage can be calculated accurately.

The first controller calculates the amount of ink consumed by one print job for each preliminarily specified calculation item. One calculation item is a normal print usage. The normal print usage is the total of the print usage on pages for which a paper is ejected to the outside of a machine without an error. The first controller outputs one job usage file. The one job usage file is data that summarizes the amount of ink used obtained for each calculation item for one print job. It is possible to calculate the amount of ink used in one print job for each item (by use). The user can easily grasp what kind of use and how much ink has been used in one print job on the basis of the one job usage file.

One calculation item is an error print usage. The error print usage is the total of the print usage of pages that have not been ejected to the outside of the machine by an error. It is possible to calculate the amount of ink used on a paper with an error. The user can grasp the amount of ink used in printing a paper with an error on the basis of the one job usage file.

One calculation item is a purge usage. The purge usage is an amount of ink used in a purge process performed in the middle of a print job. The purge process is a process for discharging ink from a nozzle to prevent clogging. It is possible to calculate the amount of ink used in the purge process (process to prevent nozzle clogging). The user can grasp the amount of ink used in the purge process during a print job on the basis of the one job usage file.

The first controller measures the time required for the job from the start to the end of a print job. The execution interval of the purge process and the amount of ink used in one purge process are preliminarily specified. The first controller obtains the number of purge executions on the basis of a value obtained by dividing the time required for the job by the execution interval. The first controller obtains the purge usage by multiplying the obtained number of purge executions by the amount of ink used in one purge process. The number of purge executions can be calculated accurately. The amount of ink used in the purge process can be calculated accurately.

While the embodiment of the present disclosure has been described, the scope of the present disclosure is not limited to the embodiment, and various variations can be practiced without departing from the spirit of the disclosure.

The present disclosure can be used for an image forming apparatus that performs printing using ink.

What is claimed is:

1. An image forming apparatus comprising:
a head configured to include a plurality of nozzles and discharge ink from the plurality of nozzles;
a first controller configured to manage a print job using the head and calculate an amount of the ink used in the print job; and
a second controller configured to control ink discharge at the head on a basis of an instruction of the first controller,
wherein when calculating the amount of the ink used, the first controller:
obtains an estimated number of discharges, which is the number of dots of the ink to be discharged, on a basis of print image data which is image data used for printing, without using information on an actual number of discharges of the ink at the head, and
obtains a print usage on a basis of a value obtained by multiplying the obtained estimated number of discharges by a discharged droplet amount per ink discharge, and
wherein the print usage is the amount of the ink used, discharged onto a paper for printing each page of the print job.

2. The image forming apparatus according to claim 1,
wherein the first controller performs halftone processing of the print image data to generate ink discharge image data,
transmits the generated ink discharge image data to the second controller, and
obtains the estimated number of discharges on a basis of the print image data before the halftone processing.

3. The image forming apparatus according to claim 1,
wherein the second controller changes the discharged droplet amount in accordance with a type of paper used for printing, and
wherein the first controller sets the discharged droplet amount to be multiplied to the estimated number of discharges to a value according to the type of paper used for printing.

4. The image forming apparatus according to claim 1,
wherein when calculating the print usage, the first controller obtains, as the print usage, a value obtained by multiplying a value obtained by dividing the estimated number of discharges by an adjustment value for adjusting a resolution of the print image data to match a print resolution of the head and the discharged droplet amount.

5. The image forming apparatus according to claim 1,
wherein the first controller obtains an amount of ink consumed by one print job for each preliminarily specified calculation item,
wherein one calculation item is a normal print usage,
wherein the normal print usage is a total of the print usage on pages for which a paper is ejected to an outside of a machine without an error,
wherein the first controller outputs a one job usage file, and
wherein the one job usage file is data that summarizes the amount of ink used, obtained for each calculation item for one print job.

6. The image forming apparatus according to claim 5,
wherein one calculation item is an error print usage, and
wherein the error print usage is a total of the print usage of pages that are not ejected to the outside of the machine by an error.

7. The image forming apparatus according to claim 5,
wherein one calculation item is a purge usage,
wherein the purge usage is an amount of the ink used in a purge process performed in a middle of the print job, and
wherein the purge process is a process for discharging ink from the nozzle in order to prevent clogging.

8. The image forming apparatus according to claim 7,
wherein the first controller measures a time required for a job from a start to an end of the print job,
wherein an execution interval of the purge process and an amount of ink used in one purge process are preliminarily specified,
wherein the first controller obtains the number of purge executions on a basis of a value obtained by dividing the time required for the job by the execution interval, and obtains the purge usage by multiplying the obtained number of purge executions by the amount of the ink used in one purge process.
